(19) United States
(12) Patent Application Publication
(10) Pub. No.: US 2025/0321923 A1
(43) Pub. Date: Oct. 16, 2025

(54) VIDEO PROCESSOR

(71) Applicant: Arm Limited, Cambridge (GB)

(72) Inventors: Damian Piotr Modrzyk, Katowice (PL); Brian Paul Starkey, Cambridge (GB); Robert Sarkoezi, Biatorbagy (HU); Håkan Lars-Göran Persson, Arlöv (SE)

(73) Assignee: Arm Limited, Cambridge (GB)

(21) Appl. No.: 19/171,945

(22) Filed: Apr. 7, 2025

(30) Foreign Application Priority Data
Apr. 12, 2024 (GB) 2405274.8
Jul. 5, 2024 (GB) 2409821.2

(51) Int. Cl. G06F 15/78; G06F 12/1045; G06F 13/28; G06T 1/20; G06T 1/60

(52) U.S. Cl. CPC G06F 15/7839; G06F 12/1054; G06F 13/28; G06T 1/20; G06T 1/60; G06F 2212/68

(57) ABSTRACT

A video processor (video processing unit, ‘VPU’) is provided having one or more processing cores, wherein a processing core comprises a respective memory interface and at least one requestor unit that is operable to issue memory transaction requests to such memory interface. The requestor unit has a respective, dedicated decoding unit that is operable to (at least) decompress data as and when it is read in to the requestor unit and to provide an uncompressed view of the data to a memory access circuit internal to the requestor unit.

### BACKGROUND

The technology described herein relates to data processing systems including video processors (video processing units, VPUs), and in particular to the compression/decompression of (video) data by, or for use by, the video processor (video processing unit (VPU)) when performing video processing.

Many data processing systems include processing resources, such as a video processor (video processing unit (VPU)), that may perform video processing (e.g. encoding and/or decoding) operations for, e.g., applications that are executing on a, e.g., main (e.g. host) processor (CPU) of the data processing system. The video processor (VPU) may thus be caused to perform video processing operations for applications executing on the main (host) processor by the main (host) processor providing to the video processor (VPU) a stream of commands (instructions) to be executed by the video processor (VPU).

A video processor (video processing unit (VPU)) may be used to perform various video processing operations. As part of this, the video processor (video processing unit (VPU)) may generally need to transfer (video) data between an (external) “off-chip” memory in which the data is (to be) stored and various “on-chip” video processing buffers. For example, a video processor (video processing unit (VPU)) may need to read in regions of reference frames when performing motion compensation (video decoding) or motion estimation (video encoding). As another example, a video processor (video processing unit (VPU)) may support streaming Direct Memory Access (DMA) on regions (e.g. horizontal stripes) of either source or destination video frames. In that case, depending on the video processing operation in question, the video processor (video processing unit (VPU)) may write a suitable output or reference frame from an “on-chip” buffer to (external) “off-chip” memory or may read input frames into an “on-chip” buffer from the (external) “off-chip” memory. Various arrangements would be possible in this regard.

To reduce bandwidth/storage requirements, the (video (e.g. frame)) data is typically stored in the (external) “off-chip” memory in a suitable ‘compressed’ format (although this need not be the case), and so the media processing system that the video processor (video processing unit (VPU)) is a part of may typically support some form of data compression/decompression.

The Applicants believe however that there remains scope for improved video processor (video processing unit (VPU)) arrangements.

### BRIEF DESCRIPTION OF DRAWINGS

Various embodiments of the technology described herein will now be described by way of example only and with reference to the accompanying drawings, in which:

FIG. 1 shows a data processing system in accordance with an embodiment of the technology described herein;

FIG. 2 shows schematically a data processing system operating in accordance with embodiments of the technology described herein;

FIGS. 3A and 3B show schematically a compressed data read transaction in accordance with an embodiment of the technology described herein;

FIGS. 4A and 4B show schematically a compressed data write transaction in accordance with an embodiment of the technology described herein;

FIG. 5 shows schematically a codec unit in accordance with an embodiment of the technology described herein;

FIG. 6 shows in more detail a video processor (video processing unit) according to an embodiment of the technology described herein;

FIG. 7 shows in more detail a ‘REF’ block within a video processor (video processing unit) according to an embodiment of the technology described herein; and

FIG. 8 shows in more detail a video Direct Memory Access (VDMA) block within a video processor (video processing unit) according to an embodiment of the technology described herein.

Like reference numerals are used for like components where appropriate in the drawings.

### DETAILED DESCRIPTION

A first embodiment of the technology described herein comprises a data processing system, the data processing system comprising:
a main (e.g. host) processor;
a memory; and
a video processor (processing unit) operable to perform video processing for applications executing on the host processor, the video processor comprising one or more processing cores, wherein a processing core of the video processor comprises:
   a memory interface that is operable to manage memory access requests from the processing core; and
   a requestor unit that is operable to issue memory transaction requests to the memory interface of the processing core that the requestor unit is a part of, the requestor unit having:
      a memory access circuit that is operable to receive memory access requests from the requestor unit and issue corresponding memory transaction requests to the memory interface of the processing core that the requestor unit is a part of; and
      a respective decoding unit (decoder) positioned between the memory access circuit of the requestor unit and the memory interface of the processing core that the requestor unit is a part of, the decoding unit (decoder) thus being operable and configured to decompress data as and when it is read in to the requestor unit and to provide an uncompressed view of the data to the memory access circuit of the requestor unit.

A second embodiment of the technology described herein comprises a data processing system, the data processing system comprising:
a main (e.g. host) processor;
a memory; and
a video processor (processing unit) operable to perform video processing for applications executing on the host processor, the video processor comprising one or more processing cores, wherein a processing core of the video processor comprises:
   a memory interface that is operable to manage memory access requests from the processing core; and
   a requestor unit that is operable to issue memory transaction requests to the memory interface of the processing core that the requestor unit is a part of, the requestor unit having:
      a memory access circuit that is operable to receive memory access requests from the requestor unit and issue corresponding memory transaction requests to the memory interface of the processing core that the requestor unit is a part of; and
      a respective decoding unit (decoder) positioned between the memory access circuit of the requestor unit and the memory interface of the processing core that the requestor unit is a part of, the decoding unit (decoder) thus being operable and configured to decompress data as and when it is read in to the requestor unit and to provide an uncompressed view of the data to the memory access circuit of the requestor unit,
the method comprising:
when a requestor unit of a processing core of the video processor (video processing unit) requires data to be read from memory in a compressed form:
the memory access circuit of the requestor unit issuing a corresponding memory transaction request to the memory interface of the processing core that the requestor unit is a part of to cause the data to be read into the requestor unit;
the memory interface of the processing core that the requestor unit is a part of then providing the compressed data to the respective decoding unit (decoder) for the requestor unit for decompressing; and
the decoding unit (decoder) provided an uncompressed view of the data to the memory access circuit of the requestor unit.

The technology described herein also extends to the operation of the video processor (video processing unit), and the video processor (video processing unit), itself.

Thus, another embodiment of the technology described herein comprises a video processor (video processing unit), the video processor comprising one or more processing cores, wherein a processing core comprises:
a memory interface that is operable to manage memory access requests from the processing core; and
a requestor unit that is operable to issue memory transaction requests to the memory interface of the processing core that the requestor unit is a part of, the requestor unit having:
   a memory access circuit that is operable to receive memory access requests from the requestor unit and issue corresponding memory transaction requests to the memory interface of the processing core that the requestor unit is a part of; and
   a respective decoding unit (decoder) positioned between the memory access circuit of the requestor unit and the memory interface of the processing core that the requestor unit is a part of, the decoding unit (decoder) thus being operable and configured to decompress data as and when it is read in to the requestor unit and to provide an uncompressed view of the data to the memory access circuit of the requestor unit.

A yet further embodiment of the technology described herein comprises a method of operating a video processor (video processing unit), the video processor comprising one or more processing cores, wherein a processing core comprises:
a memory interface that is operable to manage memory access requests from the processing core; and
a requestor unit that is operable to issue memory transaction requests to the memory interface of the processing core that the requestor unit is a part of the requestor unit having:
   a memory access circuit that is operable to receive memory access requests from the requestor unit and issue corresponding memory transaction requests to the memory interface of the processing core that the requestor unit is a part of; and
   a respective decoding unit (decoder) positioned between the memory access circuit of the requestor unit and the memory interface of the processing core that the requestor unit is a part of, the decoding unit (decoder) thus being operable and configured to decompress data as and when it is read in to the requestor unit and to provide an uncompressed view of the data to the memory access circuit of the requestor unit,
the method comprising:
when a requestor unit of a processing core of the video processor (video processing unit) requires data to be read from memory in a compressed form:
the memory access circuit of the requestor unit issuing a corresponding memory transaction request to the memory interface of the processing core that the requestor unit is a part of to cause the data to be read into the requestor unit;
the memory interface of the processing core that the requestor unit is a part of then providing the compressed data to the respective decoding unit (decoder) for the requestor unit for decompressing; and
the decoding unit (decoder) provided an uncompressed view of the data to the memory access circuit of the requestor unit.

The technology described herein relates generally to data (e.g. media) processing systems that include a video processor (video processing unit) that is operable to perform video processing operations on-demand for applications executing on a main (e.g. host) processor (e.g. a CPU) of the data processing system.

More particularly, the technology described herein relates to the decompression and/or compression of data that is to be transferred between the video processor (video processing unit) and a memory in which the data is (to be) stored in a compressed format. The memory in question may comprise any suitable memory and may be configured in any suitable and desired manner.

For example, it may be a memory that is on-chip with the video processor (video processing unit) or it may be an external memory. In an embodiment it is an external (“off-chip”) memory, such as a main memory of the overall data processing system. It may be dedicated memory for this purpose or it may be part of a memory that is used for other data as well. In an embodiment the data in question is stored in (and read from) a frame buffer.

As mentioned above, to reduce storage/bandwidth requirements, (video processing) data (e.g., such as frame data, defining one or more frames within a video stream signal) is in embodiments, and typically, stored in such memory in a suitable compressed format. A video processor (video processing unit) when performing a video processing operation, depending on the video processing operation being performed, may therefore need to read in compressed frame data from memory and/or write frame data out to memory in which that data is (to be) stored in a suitable compressed format.

The video processor (video processing unit) will however typically process and/or generate such frame data in an uncompressed format.

Any such data that is to be transferred between the video processor (video processing unit) and memory may thus need to be compressed/decompressed, as appropriate, as and when it is transferred between the video processor (video processing unit) and memory.

In particular, when data that is stored in memory in a compressed format, is to be read in to the video processor (video processing unit), prior to performing any further (video) processing operations using that data, the data should first be (and therefore is) decompressed into a suitable uncompressed format for use by the video processor (video processing unit).

For instance, the requestor unit (i.e. the particular functional unit within the video processor (video processing unit) that generated the memory access (read) request), once the required data has been read in, may, e.g., then provide the data to one or more video processing buffers associated with the requestor unit (from which the data will be further processed), or, e.g., provide the data to another functional unit for processing, and prior to doing this, the data should therefore be suitably decompressed.

This data decompression could in principle be performed at various points along the memory access (read) data path for the video processor (video processing unit).

According to the technology described herein, however, as will be explained further below, this data decompression can be (and is) performed locally to, and “on chip” with, the processing core(s) of the video processor (video processing unit), and in particular is done as and when the data is read in to the particular ‘requestor’ unit within the processing core that is requesting the data.

To facilitate this, according to the technology described herein, a requestor unit (circuit) within a processing core of the video processor (video processing unit) (and in embodiments each of a plurality of different requestor units (circuits) within a same processing core) has a respective, associated decoding unit (decoder) that is logically positioned within the memory access (read) path for the requestor unit (circuit), which decoding unit (decoder) is thus able to ‘intercept’ any memory access (read) requests originating from within that requestor unit (circuit) for which data decompression should be performed, and to then perform the required data decompression as and when data is transferred into the requestor unit (circuit).

The respective decoding unit (decoder) for a particular requestor unit (circuit) thus defines part of a memory access (read) data path of the requestor unit (circuit) in question and is correspondingly operable to receive and suitably process memory access transactions initiated by a respective memory access circuit of the requestor unit (circuit), e.g. to perform the desired data decompression. The memory access circuit (and decoding unit (decoder)) thus in embodiments supports read accesses to memory. In some embodiments, e.g. depending on the requestor unit in question, the memory access circuit (and decoding unit (decoder)) may support both read and write accesses to the memory.

Thus, as will be explained further below, some requestor units within a video processor (video processing unit) processing core may only need to support read accesses whereas other requestor units may need to support both read and write operations. For requestor units that support read accesses only, it may only be necessary to perform data decompression (i.e. to decompress data being read into the requestor unit), and so the respective decoding unit (decoder) for that requestor unit accordingly only needs to support data decompression (and in embodiments does only support data decompression). On the other hand, for requestor units that support both read and write accesses, the respective decoding unit (decoder) may need to support both compression and decompression and so the decoding unit (decoder) may also comprise suitable encoding circuitry for performing compression (such that the decoding unit (decoder) is a coding/decoding unit (codec) that supports both compression and decompression). Or, a separate encoding unit may be provided within the write data path to perform the desired compression for memory writes. Various arrangements would be possible in this regard.

Thus, a (and in embodiments each) requestor unit (circuit) within a processing core will have at least one respective memory access circuit through which it can communicate with the (external) memory and this communication is performed via the memory interface of the processing core that the requestor unit (circuit) is a part of, and through which (any and all) memory access requests from the requestor unit (circuit) are in embodiments routed. The memory access circuit of a requestor unit (circuit) within a processing core can thus communicate with the other units within the same processing core including the memory interface over a respective (internal) communications bus within the processing core.

In order to support the memory access (read and/or write) operations, the requestor unit (circuit) in embodiments comprises a suitable memory access (read/write) request generating unit (circuit) (memory access (read) request generating unit (circuit)) that is operable to and configured to generate, appropriate memory access requests, e.g. read requests for requesting (compressed) data from memory, that will then be handled via the appropriate data path. Thus, the read requests generated by the memory access request generating unit (circuit) will be passed to the memory access circuit and processed thereby to initiate the relevant memory access transactions.

Such memory access requests should thus, and in embodiments do, provide all of the appropriate information required to access the appropriate data in question to the memory access circuit. The memory access circuit correspondingly is appropriately configured to be able to handle such memory access requests and to initiate suitable memory access transactions.

The memory access circuit may suitably comprise a memory access controller, such as for example a Direct Memory Access (DMA) controller.

The operation of the decoding unit (decoder) in the technology described herein is in embodiments controlled using bus transactions, for example similarly as described in United States Patent Application Publication No. US 2024/0086340 A1 (Arm Limited), the entire content of which is incorporated herein by reference.

In embodiments, therefore, the memory access circuit of a requestor unit (circuit) is operable to receive memory access requests from (i.e. generated within) the requestor unit (circuit) and, in response to receiving a memory access request from an appropriate memory access request generator of the requestor unit (circuit), to issue corresponding bus transactions for the memory access request to the memory interface of the processing core that the requestor unit is a part of in order to perform the requested memory access.

The requestor unit (circuit) may thus be, and in embodiments is, operable to act as a bus “master” (which may also be referred to as bus “requestor” or “initiator”).

The memory access circuit of a requestor unit (circuit) may thus take any suitable and desired form but in embodiments comprises a bus interface (bus adapter) that is in communication with a communications bus, and via which the requestor unit can initiate bus transactions on the bus. The requestor unit in an embodiment is operable to initiate bus transactions by issuing bus transaction requests on a communications bus, and in an embodiment to control bus transactions initiated by the requests.

In embodiments, this is done using standard bus protocols, such as Advanced extensible Interface (AXI), as described in AMBA (Advanced Microcontroller Bus Architecture) specifications. In an embodiment, the memory access circuit comprises an AXI Direct Memory Access (DMA) external bus interface. The memory access circuit thus in embodiments comprises a communications bus comprising a read address channel, a read data channel, a write address channel, a write data channel, and a write response channel, e.g. and in an embodiment, in accordance with AXI bus protocol. Other channel arrangements would however be possible.

Correspondingly, the decoding unit (decoder) is in embodiments operable to and configured to receive bus transactions (over an (internal) bus of the requestor unit/processing core), and to, in response to such a bus transaction over a (the) communications bus, access memory (via the memory interface).

For instance, in an embodiment, the decoding unit (decoder) comprises a bus transaction initiating circuit (e.g. a bus interface) configured to initiate over the communications bus, bus transactions to access memory. In an embodiment, the decoding unit (decoder) is operable to access the memory by the bus transaction initiating circuit of the decoding unit (decoder) initiating over the communications bus, a bus transaction to access the memory. Thus, in an embodiment, the arrangement is effectively such that in response to receiving a (first) bus transaction initiated by the requestor unit, the decoding unit (decoder) initiates a (second) bus transaction to access the memory.

Thus, in embodiments, the memory access circuit comprises a bus interface that is in communication with a communications bus, and via which the requestor unit can initiate bus transactions on the communications bus to perform memory accesses, and wherein when a memory access is a request to read in data that is to be decompressed by the respective decoding unit for the requestor unit, the bus transaction causes the requested data to be read in via, and decompressed by, the decoding unit. In embodiments, the decoding unit (decoder) is operable and configured to receive bus transactions initiated by the memory access circuit and to, in response to such a bus transaction, initiate a corresponding bus transaction to perform the memory access.

Moreover, in the technology described herein, the requestor unit (circuit) may, and in embodiments does, issue bus transactions that use the respective decoding unit (decoder) for the requestor unit (circuit) via the same memory access circuit and using the same bus interface (protocol) that the requestor unit (circuit) uses for other bus transactions (e.g. transactions relating to uncompressed data or for data that is to be compressed internally to the requestor unit (circuit) without using the respective decoding unit (decoder) for the requestor unit (circuit) in the manner of the technology described herein).

Thus, as will be explained further below, the requestor unit is in embodiments also operable to initiate bus transactions to read in data that is not to be decompressed by the respective decoding unit (decoder) for the requestor unit, wherein such bus transactions are initiated by the same memory access circuit as bus transactions for data that is to be decompressed by the respective decoding unit (decoder) for the requestor unit. In that case, the memory access circuit of the requestor unit is in embodiments operable and configured to, when initiating a bus transaction for a memory access request, indicate to its respective decoding unit (decoder) whether or not the decoding unit (decoder) is to be used for decompressing the data that is transferred for that memory access request.

The memory transaction requests (e.g. the bus transactions) that the requestor unit (circuit) can initiate may include various different types of transaction requests, which may be for various different types of data to be processed by the video processor (video processing unit). However, at least some transaction requests are for memory access requests relating to compressed data for which the respective decoding unit (decoder) for the requestor unit (circuit) should be used to decompress the data as it is fetched into the requestor unit (circuit) (and any decompression relating to these memory transaction requests is accordingly handled by the respective decoding unit (decoder) for the requestor unit (circuit)).

Various arrangements would be possible in this regard.

According to the technology described herein, the respective decoding unit (decoder) for a particular requestor unit (circuit) is positioned between the memory access circuit of the requestor unit (circuit) and the memory interface of the processing core that the requestor unit is a part of.

(Thus, in contrast to what is described in United States Patent Application Publication No. US 2024/0086340 A1 (Arm Limited), the decoding unit (decoder) is more tightly integrated with the actual requestor unit (circuit) that is requesting the data for which the decompression is to be performed.)

When a requestor unit (circuit) initiates a memory read operation, for which compressed data is to be read in from (external) memory, and which data is to be decompressed by the respective decoding unit (decoder) for that requester unit (circuit), a memory request transaction (e.g. a bus transaction) is thus issued from the memory access circuit of the requestor unit (circuit) in question to the memory interface of the processing core that the requestor unit (circuit) is part of (e.g. using a suitable bus protocol over a communications bus within the processing core), and from the memory interface to the (external) memory system to cause the requested (compressed) data to be fetched in.

When the requested (compressed) data is read in to the requestor unit (circuit), it is thus first processed by the decoding unit (decoder) that performs the required decompression and provides an uncompressed view of the data to the memory access circuit (from which it is then provided to other functional units of the request unit (circuit) for further processing, as desired).

For memory read operations for data that is to be decompressed by the decoding unit (decoder), the decoding unit (decoder) is thus provided within the memory access (read) data path of the requestor unit (circuit) upstream of (and in embodiments immediately upstream of) the memory access circuit of the requestor unit (circuit). The decoding unit (decoder) can thus intercept any memory read access requests issued from the memory access circuit and when the data is read into the requestor unit (circuit), the data is read in through the decoding unit (decoder), such that the decoding unit (decoder) is operable and configured to decompress the requested data as and when it is read in to the requestor unit (circuit).

Thus, the respective decoding unit (decoder) for a requestor unit (circuit) can (and does) decompress data as and when the data is being read in to the requestor unit (circuit). The decoding unit (decoder) then provides an uncompressed view of the data to the memory access circuit of the requestor unit (circuit) (i.e. the memory access circuit that issued the memory request transaction) (and the memory access circuit then distributes the (uncompressed) data to other functional units within the requestor unit (circuit) for further processing, as appropriate).

(Correspondingly, where the decoding unit (decoder) is also operable to perform data compression for write operations (i.e. the decoding unit (decoder) is an encoding/decoding unit (codec)), which is the case for some embodiments (at least for some types of requestor unit (circuit)), the encoding/decoding unit (codec) is then provided within the memory access (write) data path of the requestor unit (circuit) downstream of (and in embodiments immediately downstream of) the memory access circuit of the requestor unit (circuit)). Thus, when the memory access circuit issues to the memory interface a bus transaction to cause data to be written out from the requestor unit (circuit), the encoding/decoding unit (codec) is operable to intercept the memory write request and to then compress the data as and when it is written out from the requestor unit (circuit).)

Thus, according to the technology described herein, a respective decoding unit (decoder) for a particular requestor unit (circuit) within a processing core (and in embodiments for multiple different requestor units (circuits) within a same processing core) is integrated into the processing core, and in embodiments integrated into the requestor unit (circuit) itself.

In other words, according to the technology described herein, the decoding unit (decoder) is local to, and on-chip with, the respective requestor unit (circuit) for which the data decompression is to be performed. The decoding unit (decoder) for a particular requestor unit (circuit) is thus more tightly coupled to the requestor unit (circuit).

This can provide various advantages, e.g. in terms of scalability, as a (and each) processing core is operable and configured to perform its own, separate data decompression, as required.

The technology described herein may therefore provide various benefits compared to other possible arrangements.

Thus, a video processor (video processing unit) according to the technology described herein, includes one or more, and in embodiments a plurality of, processing cores.

The video processor (video processing unit) in embodiments therefore further comprises a suitable controller that is operable to schedule video processing work to the processing core(s) of the video processor (video processing unit).

A (and each) processing core of the video processor (video processing unit) may generally comprise a plurality of functional units that are operable and configured to perform certain (video) processing operations. In general, a (and each) processing core of the video processor (video processing unit) may include any suitable and desired functional units. For example, a (and each) processing core may include one or more programmable processing units and also one or more dedicated fixed-function (hardware) units that are designed to perform (or accelerate) certain (video) processing operations.

Where there are a plurality of processing cores, each processing core may be substantially identical.

However, this need not be the case, and in general a video processor (video processing unit) may include any suitable arrangement of homogeneous or heterogenous processing cores.

Various arrangements would be possible in this regard.

In particular, according to the technology described herein, a (and in embodiments each) processing core of the video processor (video processing unit) comprises at least one so-called ‘requestor’ unit, which ‘requestor’ unit is operable and configured to perform respective processing operations for which data is to be transferred between the main (external) memory and the requestor unit.

For instance, one example of a suitable ‘requestor’ unit that may be, and in embodiments is, included within a video processor (video processing unit) according to the technology described herein (and that is in embodiments operable and configured in the manner of the technology described herein) would be a ‘video reference frame reading unit’ that is operable and configured to read in (regions of) reference frames (and such ‘video reference frame reading unit’ will also be referred to herein as a ‘REF’ block), e.g., and in embodiments, for performing motion estimation/motion compensation.

The video reference frame reading unit may thus be, and in embodiments is, operable and configured to read (regions of) reference frames from (external) memory and to then provide the reference frame (regions) for output to a motion estimation/motion compensation unit for further processing.

For example, a (and in embodiments each) processing core processing core in embodiments also comprises a motion estimation and/or motion compensation unit (or units) and the video reference frame reading unit is in embodiments operable to read in (regions of) reference frame data from (external) memory and provide the reference frame data to the motion estimation/motion compensation unit(s), as appropriate.

The reference frame data will typically be stored in (external) memory in a compressed format. Hence, in the technology described herein, the video reference frame reading unit is operable and configured to read in such compressed format reference frame data from (external) memory, and a respective data decoding unit (decoder) can thus be (and in embodiments is) provided for decompressing such reference frame data as and when it is read in to the video reference frame reading unit (which data decoding unit (decoder) is in embodiments arranged and configured in the manner of the technology described herein, e.g. as described above).

Thus, in embodiments, a (and in embodiments each) processing core is operable to perform motion estimation and/or motion compensation, and the processing core comprises a requestor unit comprising a video reference frame reading unit that is operable and configured to read reference frame data into the processing core for performing motion estimation and/or motion compensation, wherein the respective decoding unit for the video reference frame reading unit is operable to decompress such reference frame data as and when it is read into the video reference frame reading unit.

Another example of a suitable ‘requestor’ unit that may be, and in embodiments is, included within a video processor (video processing unit) according to the technology described herein (and that may be operable and configured in the manner of the technology described herein) would be a streaming video Direct Memory Access (VDMA) unit that is operable to stream portions of source/destination/reference frames to/from the (external) memory. For instance, the video Direct Memory Access (VDMA) unit may be able to stream video data to/from various video processing buffers.

Again, such streaming video Direct Memory Access (VDMA) unit may thus need to read in (compressed) frame data from (external) memory, and hence in the technology described herein, a respective data decoding unit (decoder) can be (and in embodiments is) provided for decompressing such frame data as and when it is read in to the streaming video Direct Memory Access (VDMA) (which data decoding unit (decoder) is again in embodiments arranged and configured in the particular manner of the technology described herein, e.g. as described above).

The streaming video Direct Memory Access (VDMA) unit may also need to write frame data to (external) memory and is in embodiments therefore also operable and configured to compress such frame data as and when it is written out from the streaming video Direct Memory Access (VDMA) unit). Thus, in the case of a streaming video Direct Memory Access (VDMA) unit, both read and write memory accesses are in embodiments supported, and so the respective data decoding unit (decoder) for the streaming video Direct Memory Access (VDMA) unit is in embodiments also operable to compress data as and when it is written out from the streaming video Direct Memory Access (VDMA) unit (in other words, the respective decoding unit (decoder) for the streaming video Direct Memory Access (VDMA) unit is in embodiments a data compression/decompression unit (codec)).

Thus, in embodiments, a (and in embodiments each) processing core comprises a requestor unit comprising a streaming video Direct Memory Access (VDMA) unit that is operable both to read input frame data into the processing core and to write output frame data to memory, wherein the respective decoding unit for the video Direct Memory Access (VDMA) unit is operable and configured to decompress input frame data as and when it is read into the video Direct Memory Access (VDMA) unit and to compress output frame data as and when it is written out by the video Direct Memory Access (VDMA) unit.

In embodiments, a (and in embodiments each) processing core of the video processor (video processing unit) comprises both a video reference frame reading unit (a REF block) and a streaming video Direct Memory Access (VDMA) unit as described above, and both of these units are operable and configured in the particular manner of the technology described herein.

That is, in embodiments, a (and each) processing core of the video processor (video processing unit) comprises both a video reference frame reading unit (a REF block) and a streaming video Direct Memory Access (VDMA) unit, and each of these units has its own respective (dedicated) decoding unit (decoder) (although as noted above, these decoding units (decoders) may be configured differently, e.g. depending on the particular memory access (e.g. read and/or write) data paths that are to be supported for the requestor unit in question, and indeed this is an effect and benefit of the technology described herein).

The ‘requestor’ units of the technology described herein are therefore operable to (at least) read in data from the (external) memory (and may or may not also be operable to write data to the (external) memory depending on the memory access operations that are supported by the requestor unit in question).

To facilitate such memory accesses, as mentioned above, a (and in embodiments each) processing core also comprises a respective memory interface that is operable to manage memory access requests from the processing core.

In embodiments, the memory interface is in the form of a memory management unit (MMU) that is operable to translate memory addresses appropriately (between logical (virtual) and physical memory addresses), e.g. in the normal manner for such memory management unit (MMU) operations.

Thus, in embodiments, the (and in embodiments each) processing core further includes a respective memory management unit (MMU) that is operable and configured to manage access to the memory and that performs logical to physical memory address translations, the memory management unit (MMU) providing the memory interface of the processing core. The (and each) requestor unit can thus issue memory request transactions to the memory management unit (MMU) (e.g. using a suitable bus protocol over a communications bus within the processing core), which memory management unit (MMU) then causes the required data to be transferred between the video processor (video processing unit) and memory.

The memory interface of the (and in embodiments each) processing core in embodiments interfaces with the memory via a memory access sub-system of the video processor (video processing unit). This memory access sub-system may be shared between plural (e.g. all) of the processing cores of the video processor (video processing unit) and may comprise, for example, a translation lookaside buffer (TLB) for caching (recently used) memory address translations, and optionally a TLB pre-fetcher, and any other suitable memory access units (circuits), and, in embodiments, a (bus) interface to the (external) memory.

For example, in embodiments, the video processor (video processing unit) comprises a set of plural processing cores, each processing core of the set of plural processing cores having a respective memory management unit (MMU) for managing memory access requests from that processing core, and wherein the video processor further comprises a shared memory access sub-system that provides a common interface to memory for the set of plural processing cores, the shared memory access sub-system comprising one or more translation lookaside buffers (TLBs) for caching logical to physical memory address translations. This has been found to provide a particularly efficient, e.g. lower-latency, arrangement.

Various arrangements would be possible in this regard.

Thus, the memory management unit (MMU) in embodiments interfaces (in embodiments via such memory access sub-system) with an (external) “off-chip” memory (system) in which the data is (to be) stored and this interface, e.g., and in embodiments, is performed via a suitable bus interconnect of the video (media) processing system of which the video processor (video processing unit) is a part of, and which bus interconnect allows the video processor (video processing unit) to communicate with other processing units of the video (media) processing system.

Various arrangements would be possible in this regard.

In embodiments, any (and all) memory access requests from the requestor unit (or units) within a processing core are thus passed to the respective memory interface (e.g. memory management unit (MMU)) of that processing core (which memory interface then issues corresponding requests to the (external) memory system, as appropriate (which requests in embodiments pass through the shared memory access sub-system, etc., as described above).

A ‘requestor’ unit according to the technology described herein is thus operable, when performing a respective processing operation, to issue to the memory interface (e.g. MMU) of the processing core that the requestor unit is a part of requests for data to be read in to the requestor unit from the main (external) memory (and depending on the requestor unit in question may also be operable to issue write requests).

It will be appreciated from the above, that at least in embodiments, a (and in embodiments each) processing core of the video processor (video processing unit) includes multiple (e.g. two), different requestor units and these requestor units each have a respective, separate (and dedicated) decoding unit (decoder) that is operable and configured to perform the required data decompression (and optionally data compression) for that requestor unit. Where a processing core includes a plurality of requestor units (e.g. both a video reference frame reading unit (a REF block) and a streaming video Direct Memory Access (VDMA) unit, as described above), these in embodiments both pass memory access requests to a single, common memory interface (e.g. a same memory management unit (MMU) of the processing core).

Thus, in embodiments, a same processing core (and in embodiments each processing core) comprises multiple, different requestor units that are operable to issue memory transaction requests to the memory interface of the processing core, and wherein the multiple, different requestor units have respective, separate decoding units.

The decoding units (decoders) for each of the requestor units are in embodiments similarly positioned along the respective memory access data paths for those requestor units, e.g., and in embodiments, between a respective memory access request interface circuit of the respective requestor units and the (common) memory interface (e.g. memory management unit (MMU)) of the processing core that the requestor units are a part of.

However, as will be explained further below, the (internal) memory access paths within the respective, different requestor units may be, and in embodiments are, different, as these can be (and in embodiments are) optimised for the particular processing operations that are supported by the respective requestor units.

For instance, when a requestor unit (circuit) requires data to be read in from (external) memory, the requestor unit (circuit) will issue, via its memory access circuit, a suitable memory access (read) request to the memory interface of the processing core that the requestor unit (circuit) is a part of and the memory interface will then cause the required data to be read in to the video processor (video processing unit) (e.g., and in embodiments, via the memory access sub-system).

The (compressed) data that is fetched in by the memory interface of the processing core is in embodiments then passed to the respective decoding unit (decoder) of the requestor unit (circuit) requiring that data, where it is then decompressed, and an uncompressed view of the data is then provided from decoding unit (decoder) to the memory access circuit of the requestor unit (circuit).

However, various further processing of the uncompressed view of the data may then be performed, depending on the functionality of the requestor unit (circuit) in question. For example, the memory access (read) data path of the requestor unit (circuit) may, and in embodiments does, include one or more latency hiding buffers, e.g. in the form of one or more FIFO (first-in-first-out) stages, e.g. for buffering the data read into the requestor unit (circuit), or otherwise, as appropriate.

In an embodiment, the requestor unit (circuit) further comprises a de-swizzle unit (circuit) that is operable and configured to de-swizzle decompressed blocks of data for the input surface to reorder the data elements in those blocks of data into a different order (where, for example, the compressed data is stored in memory in a swizzled or interleaved order) to place the data in a more appropriate order for further processing.

Thus, when performing a read operation that uses the data decoding unit (decoder), the data decoding unit (decoder) performs the required decompression and then provides a (first) uncompressed view of that data to the requestor unit (circuit). The ((first) uncompressed view of the) data is in embodiments subsequently provided to the de-swizzle unit (circuit) to perform the de-swizzling operations.

(Correspondingly, when the requestor unit (circuit) also supports the writing out of compressed data to memory, the data may first need to be swizzled and so the requestor unit (circuit) in embodiments also includes along the write access path a suitable swizzle unit (circuit). This may be a separate unit to the de-swizzle unit (circuit) but in embodiments shares at least some processing circuitry).

Thus, a (de-) swizzle unit (circuit) is in embodiments provided along the memory access data path at a suitable position between the decoding unit (decoder) and a video processing buffer or stage that uses the uncompressed data. The (de-) swizzle unit (circuit) may be (logically) positioned at any suitable and desired position along a memory access path.

Subject to the particular requirements of the technology described herein, the respective data decoding unit (decoder) for a particular requestor unit (circuit) may comprise any suitable and desired data decoding unit (decoder) that can decompress data.

The data decoding unit (decoder) should, and in embodiments does, comprise an appropriate decoding circuit(s) operable to and configured to decode (decompress) (compressed) (frame) data.

The data decoding unit (decoder) is in embodiments configured to use a block-based decoding (compression) scheme, and thus correspondingly, is configured to decode compressed data representing blocks of uncompressed data (“compression units” of uncompressed data) using a block-based encoding (compression) technique.

The data decoding unit (decoder) can be configured to use any suitable and desired block-based encoding (compression) technique. The compression scheme may encode data in a lossless or lossy manner, and using variable or fixed-rate compression, depending on the particular functionality of the requestor unit (circuit) in question. The data decoding unit (decoder) may support and be configured to be able to perform a plurality of different forms of block-based encoding, which may, e.g., and in embodiments, be set in use (e.g. on an output-by-output basis).

In an embodiment the data decoding unit (decoder) comprises (local) storage, e.g. a buffer, configured to store the data that is to be decoded, e.g. while the data is being decoded and/or before the data is sent onwards for processing, as appropriate. Thus, the data may be temporarily buffered in the decoding unit (decoder) while it is being decoded, before it is output, etc..

In some embodiments, or at least for some requestor units (circuits) (as will be explained further below), the data decoding unit (decoder) for a particular requestor unit (circuit) is also operable to compress data (and so the data decoding unit (decoder) is an data encoding/decoding unit (codec)).

In that case, the data encoding/decoding unit (codec) may comprise a respective encoder circuit and a respective decoder circuit and the encoder circuit and the decoder circuit may comprise separate circuits, or may be at least partially formed of shared processing circuits.

In some embodiments, the requestor unit (circuit) can indicate to the data decoding unit (decoder) to encoding/decoding scheme (or schemes) to be used. Thus, the data decoding unit (decoder) may be configurable. Alternatively, given that a respective data decoding unit (decoder) is for a particular requestor unit (circuit), the data decoding unit (decoder) may be configured appropriately for that particular requestor unit (circuit) (and then essentially fixed).

Various arrangements would be possible in this regard.

In embodiments, the data decoding unit (decoder) is operated and configured substantially as described in United States Patent Application Publication No. US 2024/0086340 A1 (Arm Limited), the entire content of which is incorporated herein by reference. Thus, in embodiments, a data decoding unit (decoder) corresponds to a codec as described in that reference.

In embodiments, a requestor circuit (unit) may not only support a respective memory access data path that uses the respective data decoding unit (decoder), but can, and in embodiments does, also support other memory access data paths (that do not use the respective data decoding unit (decoder) for the requestor circuit (unit)). That is, in addition to supporting the memory access data path using the decoding unit (decoder) of the technology described herein, in some embodiments, the requestor circuits (units) are also able to support other data paths to memory.

For example, there may be an uncompressed data path in which no compression/decompression is required. In embodiments, however, a requestor circuit (unit) can also support another data path for compressed data, but which does not use the data decoding unit (decoder) of the technology described herein.

In that case, the requestor circuit (unit) may include other suitable compression/decompression circuits to perform the required compression or decompression, and this is in embodiments done internally to the request circuit (unit). Hence, in that case, (compressed) data is in embodiments read in via the memory access interface of the requestor circuit (unit) (e.g. as described above) but the (compressed) data is then routed internally to an appropriate compression and/or decompression circuit to perform the required compression or decompression (i.e. rather than the compression/decompression being handled by the decoding unit (decoder) as and when the data is transferred to/from the requestor circuit (unit)).

In that case, the other memory access data paths (that do not use the decoding unit (decoder) of the technology described herein) in embodiments share at least some circuitry with the data path that uses the decoding unit (decoder) of the technology described herein. Various arrangements would be possible in this regard depending on the particular requestor circuit (unit) and an effect and benefit of the technology described herein is that the data decompression (compression) pathway can be substantially optimised based on the requestor circuit (unit) in question.

In particular, multiple (e.g. all) of the different memory access data paths including the data path that uses the decoding unit (decoder) of the technology described herein in embodiments share the same memory access circuit. In that case, data that is to be transferred using another memory access data path (that does not use the decoding unit (decoder) of the technology described herein) may be, and in embodiments is, still passed through the respective decoding unit (decoder) but is in embodiments not processed by the decoding unit (decoder) (and so passes straight through the decoding unit (decoder)).

Thus in an embodiment, the decoding unit (decoder) includes a bypass circuit that is operable to forward (over a communications bus) received transaction requests that do not indicate that the decoding unit (decoder) should respond (e.g. that are not indicated as being related to compressed data).

When issuing a memory request transaction, the memory access circuit thus in embodiments indicates to the decoding unit (decoder) whether or not the decoding unit (decoder) is to be used for that memory request transaction (and when this is indicated, the decoding unit (decoder) accordingly then performs the required decompression (or compression), as required).

In other words, the decoding unit (decoder) can in an embodiment be triggered to access memory by (receiving) an appropriate (bus) transaction request. The decoding unit (decoder) may thus be, and in an embodiment is, operable to act as a bus “slave” (which may also be referred to as a bus “completer” or “follower”). Moreover, the decoding unit (decoder) in an embodiment is operable to access memory via a communications bus (during a bus transaction).

Thus, a (bus) transaction request that initiates a “data decoder” bus transaction may include an indication that the request relates to compressed data (that should be handled by the decoding unit (decoder)), and the decoding unit (decoder) may respond appropriately on that basis.

In an embodiment, the requestor unit can issue a specific, in an embodiment selected, in an embodiment predetermined, signal that indicates that an associated bus transaction relates to compressed data (and so should comprise the decoding unit (decoder) accessing the memory). Correspondingly, the decoding unit (decoder) in an embodiment responds appropriately (accesses the memory) in response to receiving such a “compressed data” signal.

In an embodiment, the decoding unit (decoder) determines whether the decoding unit (decoder) should access memory in response to a received bus transaction request, in an embodiment based on whether or not the request indicates (e.g. by including an appropriate signal) that the decoding unit (decoder) should do so (e.g. whether or not the request is indicated as being related to compressed data). When it is determined that the decoding unit (decoder) should access memory in response to a received bus transaction request, the decoding unit (decoder) in an embodiment accesses the memory as appropriate.

When, however, it is not determined (it is other than determined) that the decoding unit (decoder) should access memory, the decoding unit (decoder) in an embodiment does not access the memory. The decoding unit (decoder) may not respond (at all) to a bus transaction request that does not indicate that the decoding unit (decoder) should respond (that is not indicated as being related to compressed data). However, in an embodiment, the decoding unit (decoder) is operable to forward (over a communications bus) any bus transaction requests that do not indicate that the decoding unit (decoder) should respond (e.g. that are not indicated as being related to compressed data), e.g. and in an embodiment, such that the forwarded requests can reach and trigger other components of the system via the communications bus appropriately.

In other embodiments, the system may be configured such that only bus transaction requests that a decoding unit (decoder) should respond to are received by the decoding unit (decoder), e.g. such that requests that are not intended for the decoding unit (decoder) bypass the decoding unit (decoder).

Various arrangements would be possible in this regard.

The requestor unit (circuit) may also indicate to the decoding unit (decoder) any other suitable and desired information or properties for controlling the decoding unit (decoder).

For example, the requestor unit (circuit) may indicate to the decoding unit (decoder) encoding parameters and/or properties that the codec should use when compressing uncompressed data or when decompressing compressed data to produce decompressed data. The requestor unit (circuit) may, for example and in an embodiment, indicate an encoding scheme that should be used.

Similarly, in another example, the requestor unit (circuit) can indicate to the decoding unit (decoder) parameters and/or properties of uncompressed data that the codec is to compress or parameters and/or properties of decompressed data that the codec is to produce. The indicated parameters and/or properties can be any suitable parameters or properties, such as data representation parameters and/or properties, such as RGB/RGBA/YUV, number of components, number of bits (per component), floating point/unsigned/signed integers, etc..

Such indications can be indicated to the decoding unit (decoder) in any suitable and desired manner but in embodiments this is done using the techniques described in this regard in United States Patent Application Publication No. US 2024/0086340 A1 (Arm Limited).

Various arrangements would be possible in this regard.

Thus, in embodiments, a particular requestor circuit (unit) may support multiple, different data paths to (external) memory. In embodiments, a selection can thus be, and is made, between the different data paths to (external) memory based on the data path that is to be used for a particular processing operation (and particularly memory transaction for that processing operation)). The selection of which data path is to be used can be specified, for example, by the host processor such that the data path is programmable, e.g. in software.

The above description describes the main elements of a video processor (video processing unit) according to the technology described herein. However, it will be appreciated that in addition to the various requestor unit(s) and memory interfaces described above, there may of course be (and typically will be) various other functional units within a (and in embodiments each) processing core.

For example, as alluded to above, a (and in embodiments each) processing core in embodiments also comprises respective units for performing motion estimation and/or motion compensation (and the reference frame reading unit is in embodiments operable to read in data for those units). A processing core may also suitably comprise any or all of: (i) a deblock unit (deblocking filter), (ii) a bitstream (analyser) unit, and (iii) a video transform unit, and the video Direct Memory Access (VMDA) may generally be operable to transfer data between (external) memory and any of such units.

There may also be other functional units within a processing core of the video processor (video processing unit) that can also access the (external) memory but that may not be operated and configured in the manner of the technology described herein (and so do not correspond to the ‘requestor’ units that are operated and configured in the manner of the technology described herein, e.g. as described above).

For example, in addition to the video Direct Memory Access (VMDA) described above, a processing core may also comprise a (separate) “soft” Direct Memory Access (SDMA) unit, e.g. as defined for Xilinx's Multi-Port Memory Controller (MPMC).

In that case, the “soft” Direct Memory Access (SDMA) unit need not (and in embodiments does not) have a respective decoding unit (decoder) that is operable and configured in the particular manner according to the technology described herein.

Various arrangements would be possible in this regard.

Thus, subject to the particular requirements of the technology described herein, the video processor (video processing unit), and the processing cores thereof, may comprise any suitable and desired functional units or circuitry that a video processor (video processing unit) may desirably contain.

The video processor (video processing unit) may be used to perform any suitable and desired video processing operations. Typically, this will include video coding/decoding operations.

Correspondingly, the data that is to be processed by/for the video processor (video processing unit) may comprise any suitable and desired data. Typically this will include data for video frames.

For example, the data in question may generally be frame data that has been generated by being appropriately rendered and stored into a memory (e.g. frame buffer) by a graphics processing system (a graphics processor).

Additionally or alternatively, the data may be data that has been decoded and stored into a memory (e.g. frame buffer) by the video processor (video processing unit) itself (and that is now to be read back in for further processing).

Additionally or alternatively, the data in question may be generated by a digital camera image signal processor (ISP), or other image processor.

In some embodiments, the video processor and/or data processing system comprises, and/or is in communication with, one or more memories and/or memory devices that store the data described herein, and/or store software for performing the processes described herein. The video processor and/or data processing system may also be in communication with and/or comprise a host microprocessor, and/or with and/or comprise a display for displaying images based on the data generated by the video processor.

The technology described herein can be implemented in any suitable system, such as a suitably configured micro-processor based system. In an embodiment, the technology described herein is implemented in a computer and/or micro-processor based system.

The various functions of the technology described herein can be carried out in any desired and suitable manner. For example, the functions of the technology described herein can be implemented in hardware or software, as desired. Thus, for example, unless otherwise indicated, the various functional elements and stages of the technology described herein may comprise a suitable processor or processors, controller or controllers, functional units, circuitry, processing logic, microprocessor arrangements, etc., that are operable to perform the various functions, etc., such as appropriately dedicated hardware elements and/or programmable hardware elements that can be programmed to operate in the desired manner.

It should also be noted here that, as will be appreciated by those skilled in the art, the various functions, etc., of the technology described herein may be duplicated and/or carried out in parallel on a given processor. Equally, the various processing stages may share processing circuitry, etc., if desired.

Subject to any hardware necessary to carry out the specific functions discussed above, the video processor can otherwise include any one or more or all of the usual functional units, etc., that video processors include.

It will also be appreciated by those skilled in the art that all of the described embodiments of the technology described herein can, and in an embodiment do, include, as appropriate, any one or more or all of the features described herein.

The methods in accordance with the technology described herein may be implemented at least partially using software e.g. computer programs. It will thus be seen that when viewed from further embodiments the technology described herein provides computer software specifically adapted to carry out the methods herein described when installed on a data processor, a computer program element comprising computer software code portions for performing the methods herein described when the program element is run on a data processor, and a computer program comprising code adapted to perform all the steps of a method or of the methods herein described when the program is run on a data processing system. The data processor may be a microprocessor system, a programmable FPGA (field programmable gate array), etc..

The technology described herein also extends to a computer software carrier comprising such software which when used to operate a graphics processor, renderer or microprocessor system comprising a data processor causes in conjunction with said data processor said processor, renderer or system to carry out the steps of the methods of the technology described herein. Such a computer software carrier could be a physical storage medium such as a ROM chip, CD ROM, RAM, flash memory, or disk, or could be a signal such as an electronic signal over wires, an optical signal or a radio signal such as to a satellite or the like.

It will further be appreciated that not all steps of the methods of the technology described herein need be carried out by computer software and thus from a further broad embodiment the technology described herein provides computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions either fixed on a tangible, non transitory medium, such as a computer readable medium, for example, diskette, CD ROM, ROM, RAM, flash memory, or hard disk. It could also comprise a series of computer readable instructions transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink wrapped software, pre loaded with a computer system, for example, on a system ROM or fixed disk, or distributed from a server or electronic bulletin board over a network, for example, the Internet or World Wide Web.

A number of embodiments of the technology described herein will now be described.

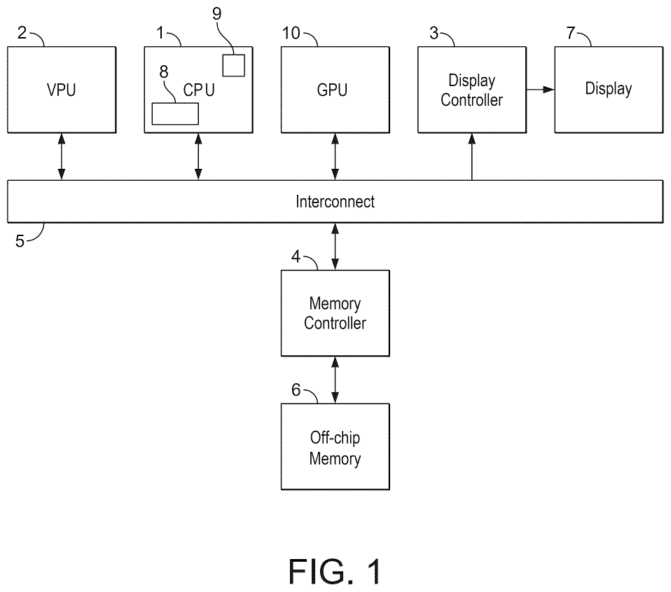

FIG. 1 shows a data processing system in accordance with an embodiment.

The exemplary data processing system shown in FIG. 1 comprises a host processor comprising a central processing unit (CPU) 1, a graphics processor (graphics processing unit (GPU)) 10, a video processing unit (VPU) 2, and a display controller 3. As shown in FIG. 1, these processing units can communicate via a bus interconnect 5 and have access to an off-chip memory system ((main) memory) 6 via the bus interconnect 5 and a memory controller 4. Other processing units may be provided.

In use of this system, the CPU 1, and/or VPU 2 and/or GPU 10 will generate frames (images) to be displayed, and the display controller 3 will provide frames to a display 7 for display. To do this the CPU 1, and/or VPU 2 and/or GPU 10 may read in data from the memory 6 via the interconnect 5, process that data, and return data to the memory 6 via the interconnect 5. The display controller 3 may then read in that data from the memory 6 via the interconnect 5 for display on the display 7.

The graphics processor or graphics processing unit (GPU) 10, produces rendered tiles of an output frame intended for display on a display device, such as a screen. The output frames are typically stored, via the memory controller 4, in a frame or window buffer in the off-chip memory 6.

The video processor or video processing unit (VPU) 2, produces pixel blocks of an output frame intended for display on a display device, such as a screen. The output frames are typically stored, via the memory controller 4, in a frame or window buffer in the off-chip memory 6. In such an arrangement, the video processor (VPU) 2 receives encoded blocks of video data, e.g. from memory or elsewhere, and decodes the data blocks to generate blocks of pixel data to be displayed. The encoded blocks of video data may be, e.g., differential encoded blocks of video data, i.e. encoded with a motion vector and a residual (although this is not necessary).

The display controller 3 operates to read an output frame from the frame buffer in the off-chip memory 6 via the memory controller 4 and to send it to a display for display.

For example, an application 8, such as a game, executing on the host processor (CPU) 1 may require the display of graphics processing unit (GPU) rendered frames on the display 7. In this case, the application 8 will send appropriate commands and data to a driver 9 for the graphics processing unit 10 that is executing on the CPU 1. The driver 9 will then generate appropriate commands and data to cause the graphics processing unit 10 to render appropriate frames for display and store those frames in appropriate frame buffers in main memory 6.

The display controller 3 will then read those frames into a buffer for the display from where they are then read out and displayed on the display panel of the display 7. As part of this processing, the graphics processor 10 will read in data, such as textures, geometry to be rendered, etc. from the memory 6, process that data, and then return data to the memory 6 (e.g. in the form of processed textures and/or frames to be displayed), which data will then further, e.g. as discussed above, be read from the memory 6, e.g. by the display controller 3, for display on the display 7.

Thus, there will be a need to transfer data between the memory 6 and processing units (e.g. CPU 1, VPU 2, GPU 10, display controller 3) of the data processing system. In order to facilitate this, and to reduce the amount of data that needs to be transferred to and from memory during processing operations, the data may be stored in a compressed form in the memory 6.

As a processing unit (e.g. CPU 1, VPU 2, GPU 10, display controller 3) will typically need to operate on the data in an uncompressed form, this accordingly means that data that is stored in the memory 6 in compressed form may need to be decompressed before being processed by the processing unit. Correspondingly, data produced by a processing unit (e.g. CPU 1, VPU 2, GPU 10) may need to be compressed before being stored in the memory 6.

To facilitate such compression and decompression of data that passes between the memory 6 and processing units, the data processing system in the technology described herein includes a compression codec (or codecs) to perform the required compression and decompression operations.

The present embodiments relates particularly to the compression and decompression of data between the memory 6 and the video processing unit (VPU) 2. In particular, as will be described further below, compression codecs to perform the required compression and decompression operations are according to the present embodiments integrated into the video processing unit (VPU) 2.

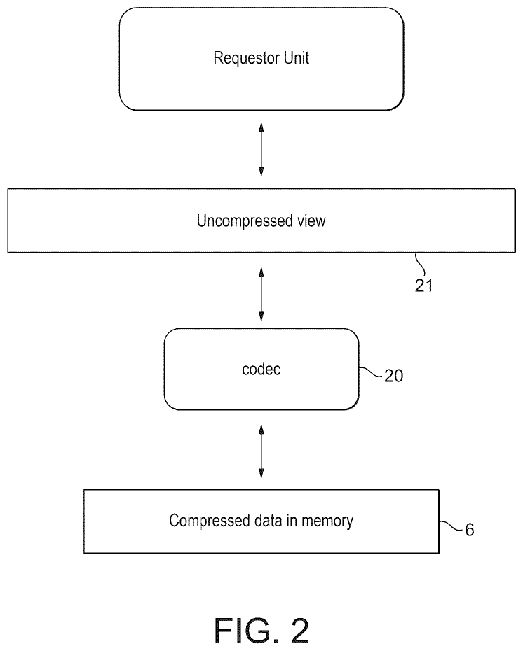

FIG. 2 shows schematically elements of a compression system that are relevant to the operation of the present embodiments, and in particular to the transferring of data between the memory system 6 and a particular ‘requestor’ unit in a compressed form.

As shown in FIG. 2, a codec 20 is provided logically between a particular ‘requestor’ unit and the memory 6. The codec 20 is then operable to decompress data received from the memory system 6 before providing that data in an uncompressed form to the requestor unit (for further processing, and, conversely, (at least in some embodiments) to compress data received from a ‘requestor’ unit that is to be written to the memory system 6 prior to writing that data to the memory 6 in compressed form.

As illustrated in FIG. 2, the codec 20 operates to effectively present an uncompressed view 21 of compressed data in the memory 6 to a particular requestor unit that is acting as bus master (initiator/requestor), such that the requestor unit can access that uncompressed view of the compressed data through bus transactions.

As discussed in United States Patent Application Publication No. US 2024/0086340 A1 (Arm Limited), the use of bus transactions to communicate with and control a codec in this manner can provide various advantages for compression and decompression in a data processing system. For example, the compression and decompression can be controlled using existing bus protocols, such as AXI. Thus, for example, a processing unit can control a codec using the same bus interface that it uses for other (e.g.) “direct” bus transactions. Moreover, the compressed data can be accessed in a “random access” manner.

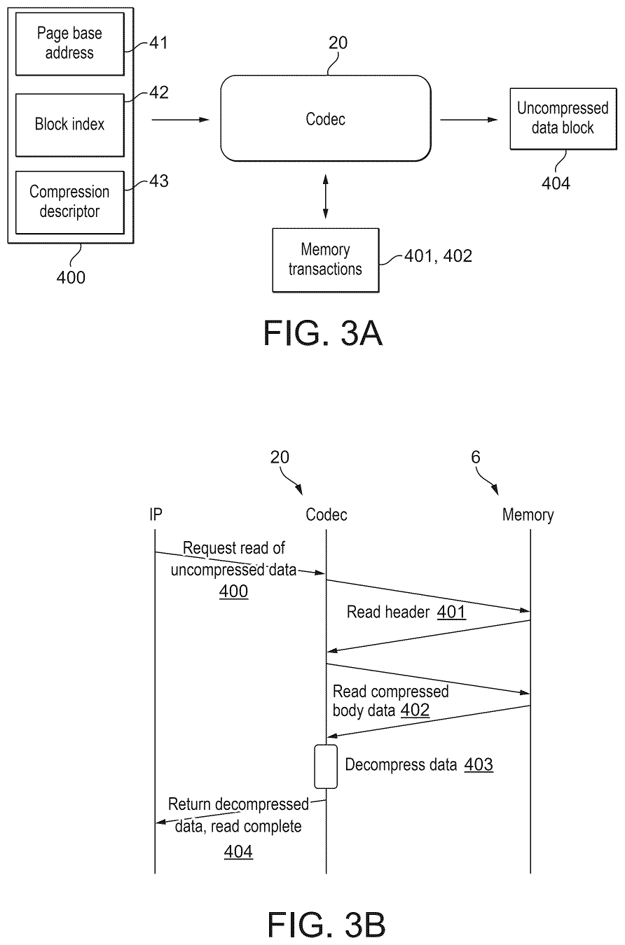

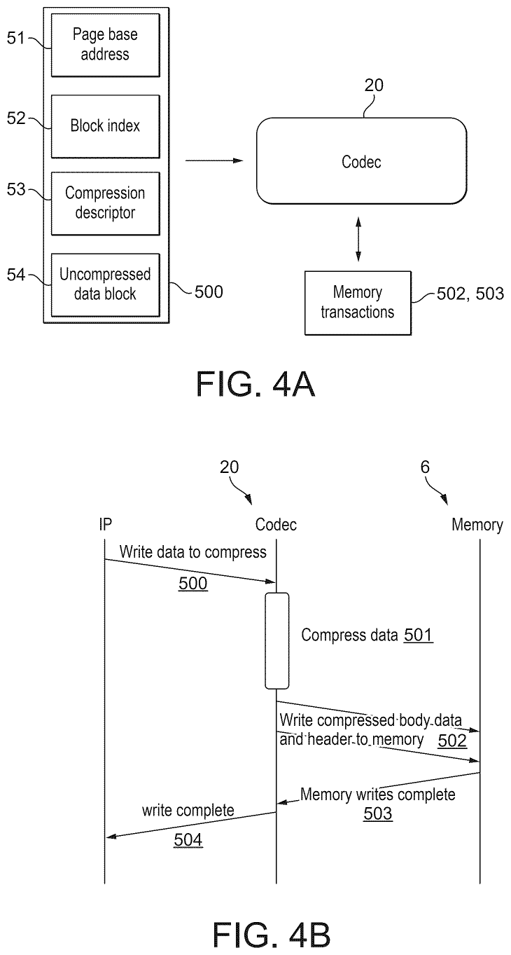

FIGS. 3A, 3B and 4A, 4B illustrate bus transactions in which a particular requestor unit can access an uncompressed view of compressed image data that is stored in a compressed frame buffer in the memory 6 in accordance with embodiments of the technology described herein.

FIG. 3A schematically illustrates a compressed data read transaction, and FIG. 3B is a corresponding sequence diagram, according to an embodiment.

As illustrated in FIGS. 3A and 3B, when a requestor unit requires data that is stored in the memory 6 in a compressed data block, the requestor unit issues a read transaction request 400 on a read address channel. This includes the processing unit issuing a “COMPRESSED” signal that indicates that the request relates to compressed data in the memory 6, and should trigger a bus transaction that involves the codec 20.

As shown in FIG. 3A, the read transaction request 400 may further include an indication 41, 42 of the memory address of the required compressed data block, and a compression descriptor 43. The memory address information includes an indication 41 of the location of header data for the compressed data block, and an indication 42 of the location of the block within the body data associated with the header.

The compression descriptor 43 is a signal vector that identifies the compression mechanism (codec) that the required data block is compressed in accordance with, and identifies the data format and data type in which the uncompressed data should be returned to the processing unit (e.g. RGB, RGBA, YUV, number of components, bits per component, whether data values are unsigned/signed integers, floating point numbers, etc.).

As shown in FIG. 3B, the codec 20 recognises and intercepts the request (step 400), reads header information for the required compressed data block from the memory 6 using the header memory address information 41 (step 401), and then reads the appropriate compressed data block using the body memory address information 42 (step 402). The codec then decompresses the read compressed data block in accordance with the compression descriptor information 43 (step 403), provides the decompressed data to the requestor unit and signals to the requestor unit that the read transaction is complete on a read data channel of the relevant bus to which the requestor unit is issuing the bus transaction (step 404).

FIG. 4A schematically illustrates a compressed data write transaction, and FIG. 4B is a corresponding sequence diagram, according to an embodiment.

As illustrated in FIGS. 4A and 4B, when a requestor unit requires (uncompressed) data that is stored in the memory 6 in a compressed data block, the requestor unit issues a write transaction request on the relevant bus via its bus interface (step 500). This includes the processing unit issuing a “COMPRESSED” signal on a write address channel of the bus 5 that indicates that the request relates to compressed data in the memory 6, and should trigger a bus transaction that involves the codec 20.

As shown in FIG. 4A, the write transaction request may further include the (uncompressed) data 54 that the requestor unit requires to be stored in compressed form in the memory 6, an indication 51, 52 of the memory address at which the compressed data block should be stored in the memory 6, and a compression descriptor 53. The memory address information includes an indication 51 of the memory location for header data for the compressed data block, and an indication 52 of the memory location for the block within body data associated with the header.

In this case, the compression descriptor 53 is a signal vector that identifies the compression mechanism (codec) that the data should be compressed in accordance with, and identifies the data format and data type in which the uncompressed data is provided (e.g. RGB, RGBA, YUV, number of components, bits per component, and whether data values are unsigned/signed integers, floating point numbers, etc.).

As shown in FIG. 4B, the codec 20 recognises and intercepts the request, compresses the uncompressed data 54 in accordance with the compression descriptor information 53 (step 501), and writes the compressed data block to the memory 6 together with appropriate header information based on the memory address information 51, 52 (step 502). When the memory write is complete (step 503), the codec 20 signals to the requestor unit that the write transaction is complete on a write response channel of the bus 5 (step 504).

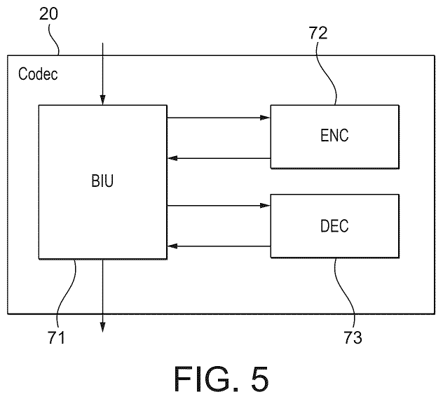

FIG. 5 shows the codec unit 20 in more detail according to an embodiment. As shown in FIG. 5, the codec unit 20 includes a bus interface module (BIU) 71, an encoder module, and a decoder module 73. The bus interface module 71 receives bus transactions via the relevant communications bus and determines the manner in which the codec 20 should respond to received bus transactions.

In the case of a compressed data read transaction, the bus interface module 71 passes compressed data to be decompressed to the decoder module 73, and the decoder module 73 decompresses the data, and returns decompressed data to the bus interface module 71. The bus interface module 71 then forwards the decompressed data to the requestor unit. The bus interface module 71 may initiate a bus transaction to read the compressed data to be decompressed from the memory 6.

In the case of a compressed data write transaction, the bus interface module 71 passes data to be compressed to the encoder module 72, and the encoder module 72 compresses the data, and returns compressed data to the bus interface module 71. The bus interface module 71 then forwards the compressed data to the memory 6. The bus interface module 71 may initiate a bus transaction to write the compressed data to the memory 6.

In the case of a bus transaction that is not indicated as being related to compressed data, the bus interface module 71 appropriately forwards the bus transaction without the encoder or decoder modules 72, 73 being activated.

The present embodiments relate particularly to the integration of such a compression system into a video processing unit (VPU) 2.

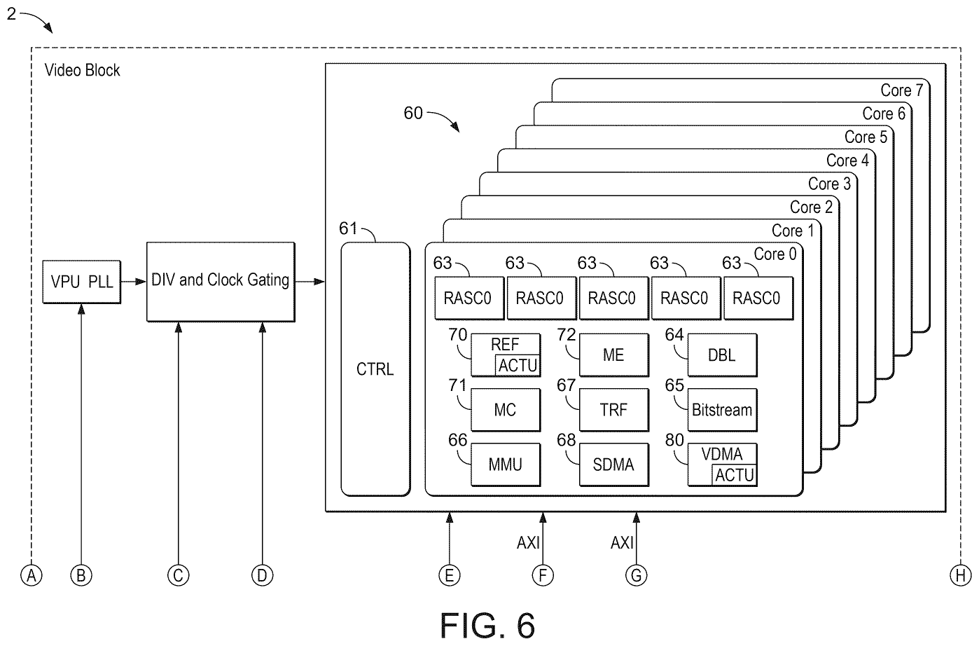

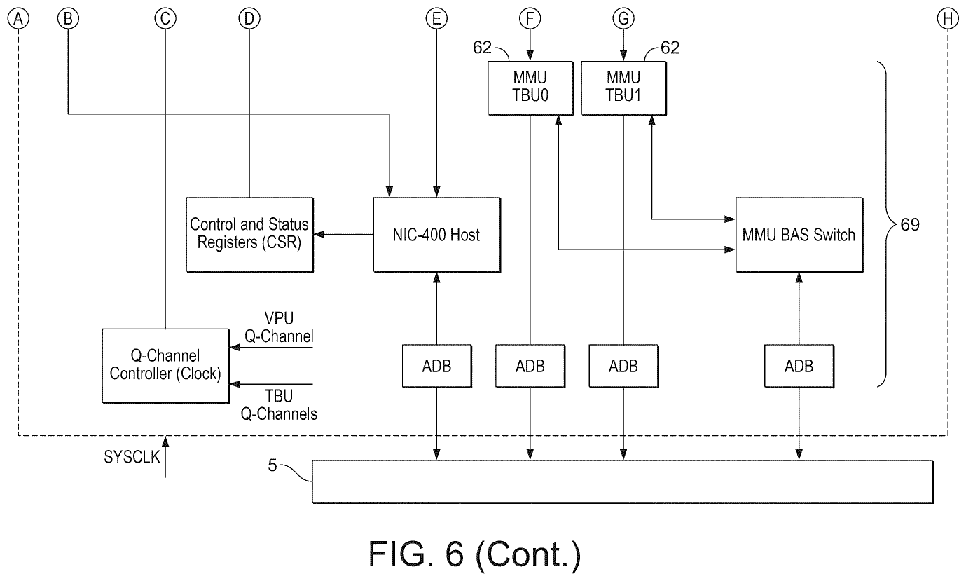

FIG. 6 shows in more detail the video processing unit (VPU) 2 according to an embodiment of the technology described herein.

As shown in FIG. 6, the video processing unit (VPU) 2 includes a set of plural (parallel) processing cores 60. The video processing unit (VPU) 2 also includes a suitable controller 61 that is operable to communicate with the host processor (central processing unit (CPU) 1) and to schedule processing work to the processing cores 60 of the video processing unit (VPU) 2. For instance, the driver 9 in embodiments programs appropriate control registers in the controller 61, and the controller 61 furthers translates this configuration into hardware control signals for the respective functional units of the video processing unit (VPU) 2.

A (and in embodiments each) processing core includes a plurality of functional units. For example, as shown in FIG. 6, a processing core in embodiments includes a plurality of reconfigurable application specific computing (RASC0) units 63. The processing core in embodiments also includes various essentially fixed-function (hardware) units (circuits) that are dedicated to performing or accelerating certain video processing operations.

For instance, as shown in FIG. 6, a processing core may, and in embodiments does, include any of (and in embodiments all of), a memory management unit (MMU) 66 that manages access to the memory 6, a deblock unit 64 (deblocking filter), a bitstream (analyser) unit 65, a video transform unit 67, a motion compensation unit 71, a motion estimation unit 72, and a “soft” Direct Memory Access (SDMA) unit 68. The processing core in embodiments also includes one or more units that perform memory accesses and that are in embodiments therefore operated and configured as ‘requestor’ units, e.g. as described above (and that are provided with respective, dedicated compression units).

In FIG. 6, the ‘requestor’ units of the processing core in particular comprise a REF block 70 that, as will be explained further below, is operable and configured to read in (regions of) reference frames (e.g.) for performing motion compensation/estimation operations and to provide the reference frame (regions) to the motion compensation unit 71 or a motion estimation unit 72, as appropriate, and a video Direct Memory Access (VDMA) unit 80.

As shown in FIG. 6, according to the present embodiments, each of the REF block 70 and the video Direct Memory Access (VDMA) unit 80 has a respective, integrated codec unit (referred to herein as an ‘ACT unit’ (‘ACTU’)) that is operable to perform the required decompression (and optionally compression, at least for the video Direct Memory Access (VDMA) unit 80) of data that is to be transferred between the memory 6 and those units (and which codec unit (ACTU) is operable and controllable in the manner of the codec 20 described above under the respective control of the REF block 70 and the video Direct Memory Access (VDMA) unit 80, as appropriate).

That is, according to the present embodiments, these requestor units within the processing core of the video processing unit (VPU) 2 have an integrated codec unit that can be controlled in the manner described above using internal bus transactions. These codecs are thus (logically) positioned within the respective requestor units such that they sit in the memory access path (i.e. between the relevant bus interface of the requestor unit and the memory management unit (MMU) 66 that interfaces with a respective memory access sub-system 69 of the video processing unit (VPU) 2.

The processing core, and in particular the requestor units of the processing core (namely the REF block 70 and the video Direct Memory Access (VDMA) unit 80) are thus operable to issue memory access transactions via the memory management unit (MMU) 66 which memory access transactions are passed to the memory access sub-system 69 of the video processing unit (VPU) 2 (which memory access sub-system 69 as shown in FIG. 6 may include one or more translation buffer units (TBUs) (translation lookaside buffers) 62, and any other suitable memory access units (circuits), etc. for interfacing with the off-chip memory 6) and are ultimately communicated over the bus interconnect 5 to the external memory controller 4 to perform the desired accesses to the off-chip memory 6.

The requestor units of the processing core (namely the REF block 70 and the video Direct Memory Access (VDMA) unit 80) thus support respective memory access data paths.

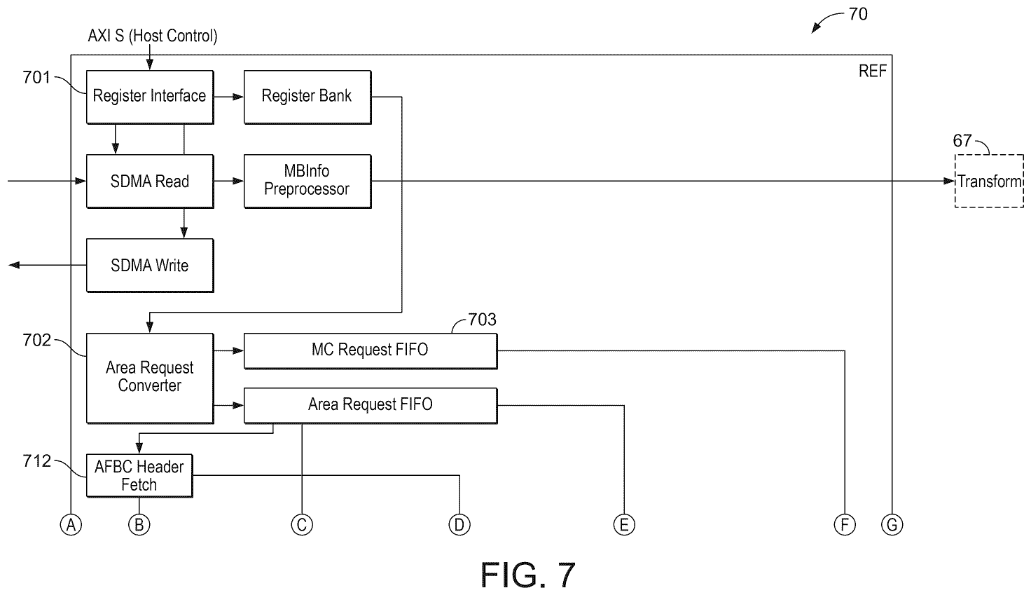

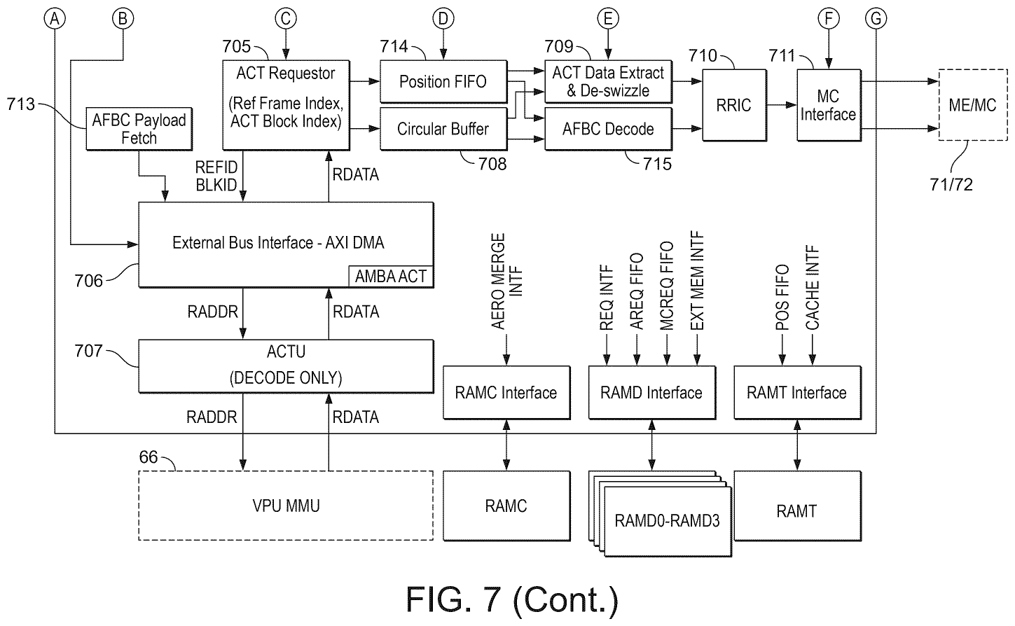

FIG. 7 shows in more detail the internal structure of the REF block 70 according to the present embodiments.

As shown in FIG. 7, the REF block 70 includes an appropriate register interface 701 that is operable to receive commands from the controller 61 of the video processing unit (VPU) 2. These commands may cause the REF block 70 to perform a particular processing operation and may also indicate a particular data path that is to be used by the REF block 70.

For example, the REF block 70 may be operable and configured to read in from the memory 6 data for regions of reference frames which reference frame data is then provided to the motion estimation/compensation units 71,72 to perform the appropriate motion estimation/compensation operations.

The reference frame data will be stored in the memory 6 in compressed format and so the data path for reading in such data should include a decompression unit (decoder) to perform the required decompression. In the present embodiments, as shown in FIG. 7, the REF block 70 is thus provided with a respective ACT (decoder) unit 707 that is positioned (logically) between an AXI Direct Memory Access (DMA) external bus interface 706 of the REF block 70 and the memory management unit (MMU) 66 of the video processing unit (VPU) 2. The operation of the ACT (decoder) unit 707 corresponds to the operation of codec described above, and is thus operable to decompress compressed (frame) data in response to read requests to that effect generated from the REF block 70.

(It will be appreciated here that the REF block 70 may only need to support read accesses to the off-chip memory 6, and so in embodiments the ACT (decoder) unit 707 is only operable to perform decompression. The ACT (decoder) unit 707 in embodiments (only) supports lossless decompression. However, in principle the ACT (decoder) unit 707 may support both decompression and compression.)

Thus, when the register interface 701 receives commands to fetch in such data to perform a motion estimation/compensation operation, when the data is to be decompressed by the ACT (decoder) unit 707, the REF block 70 processes such commands by converting the command into an area request (by area request converter 702). A suitable motion estimation/compensation request in then added to a respective motion estimation/compensation request FIFO 703 and in parallel to this a corresponding area request is added to a respective area request FIFO 704. The area requests are processed from the area request FIFO 704 by an appropriate ACT requestor unit 705 that generates requests for data to be fetched in and decompressed by the ACT (decoder) unit 707. Thus, when a memory access is to be performed, the ACT requestor unit 705 initiates an appropriate bus transaction, as described above.

The memory access requests generated by the ACT requestor unit 705 are thus passed via the AXI Direct Memory Access (DMA) external bus interface 706 of the REF block 70 to the memory management unit (MMU) 66 via the ACT (decoder) unit 707 (although since these are read requests the ACT (decoder) unit 707 does not do anything at this point and instead simply forwards the request to the memory management unit (MMU) 66 (i.e. by initiating a further bus transaction to do this, as described in FIG. 5)).

The memory management unit (MMU) 66 will then cause the requested (compressed) area data to be fetched in from memory 6 and this data is then returned to the REF block 70 where it is first processed by the ACT (decoder) unit 707 that performs the required decompression and provides an uncompressed view of the data to the AXI Direct Memory Access (DMA) external bus interface 706. The AXI Direct Memory Access (DMA) external bus interface 706 then returns the uncompressed via of the data to the ACT requestor unit 705 which then adds the data into an appropriate circular buffer 708.

As shown in FIG. 7, the REF block 70 also includes a de-swizzle unit (circuit) 709 that is operable and configured to de-swizzle decompressed blocks of data for the input surface to reorder the data elements in those blocks of data into a different order (where, for example, the compressed data is stored in memory in a swizzled or interleaved order) to place the data in a more appropriate order for processing by a motion estimation/compensation unit.

The de-swizzle unit (circuit) 709 thus performs the required de-swizzle operations and passes the resulting data to a RRIC block 710 from which it is then passed onto a suitable interface 711 for the motion estimation/compensation units 71,72 (and from the interface 711 to the motion estimation/compensation units 71,72 for further processing).

The above describes a particular data path for reading in compressed data wherein the compressed data is to be decompressed by the ACT (decoder) unit 707. However, as shown in FIG. 7, the REF block 70 may also support various other data paths.

For example, the REF block 70 may also comprise an interface to the “soft” Direct Memory Access (SDMA) unit via which it can fetch in data that is to be provided to the transform unit 67.

The REF block 70 may also comprise another data path to memory 6 that still performs data decompression but does not use the ACT (decoder) unit 707. In particular, this another data path may support Arm Frame Buffer Compression (AFBC) (as described, for example, in United States Patent Application Publication No. US 2013/0034309 A1, the entire contents of which is incorporated herein by reference). In that case, the area requests that are processed from the area request FIFO 704, rather than being processed by the ACT requestor unit 705, are instead passed to an appropriate AFBC header fetch unit 712 that then issues access requests for AFBC header data to the AXI Direct Memory Access (DMA) external bus interface 706 and inserts corresponding entries into position FIFO 714. An AFBC payload fetch unit 713 is also provided that issues access requests for AFBC payload data to the AXI Direct Memory Access (DMA) external bus interface 706.

As shown in FIG. 7, these (AFBC) access requests also pass through the ACT (decoder) unit 707 to the memory management unit (MMU) 66 but the ACT (decoder) unit 707 does not perform any compression/decompression and instead simply forwards the requests on. In this case, when the compressed data is read in, the compressed data is passed through the ACT (decoder) unit 707 to the AXI Direct Memory Access (DMA) external bus interface 706 (without performing decompression). The data is then passed through various buffers to an appropriate AFBC decode unit 715 where it is then decompressed and then provided for output to the motion estimation/compensation units 71,72 (via the RRIC 710 and interface 711, as described above).

Thus, it will be appreciated that both memory access paths share at least some processing circuitry in common and that the data path that uses the ACT (decoder) unit 707 can thus be added into the REF block 70 in a particularly efficient manner (taking advantage of some of the existing circuitry for the AFBC data path).

For example, compared to a REF block 70 that only supports the AFBC data path described above, in order to support the additional data path that uses the ACT (decoder) unit 707, in addition to adding the ACT (decoder) unit 707 itself, it is then only required to add a suitable ACT requestor unit 705 and de-swizzle unit (circuit) 709 in order to support that data path, and the data path may otherwise re-use (or share) existing circuitry within the REF block 70. In embodiments, these data paths are therefore exclusive so that only one data path is active at a time.

As mentioned above, the commands from the controller 61 of the video processing unit (VPU) 2 in embodiments indicate which data path is to be used, such that the REF block 70 can be programmed (in software) to use different data paths, as desired. Thus, the REF block 70 shown in FIG. 7 supports both an AFBC data path and an ACT data path, and is software programmable by the video processing unit (VPU) 2 driver to select which data path is to be used (e.g. based on the application requirements).

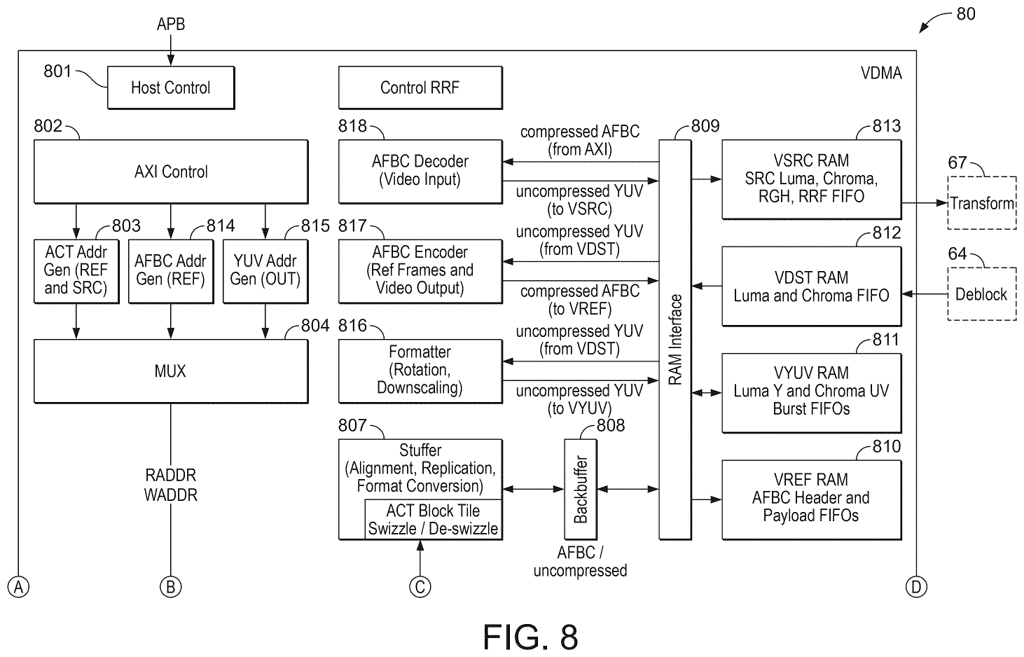

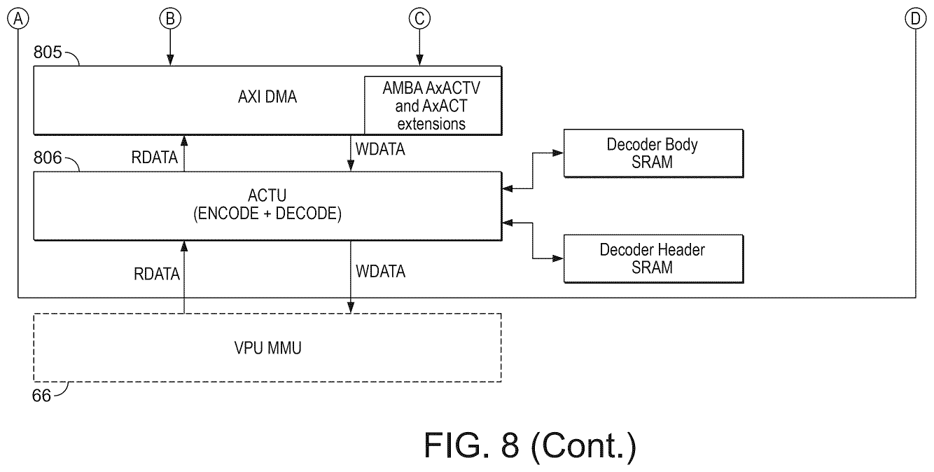

FIG. 8 shows in more detail the internal structure of the video Direct Memory Access (VDMA) unit 80 according to the present embodiments.

As shown in FIG. 8, the video Direct Memory Access (VDMA) unit 80 includes an appropriate host control interface 801 that is operable to receive commands from the controller 61 of the video processing unit (VPU) 2.

These commands can then be passed to a AXI control 802. The AXI control 802 manages internal communications within the video Direct Memory Access (VDMA) unit 80 and is operable to support multiple data paths to the off-chip memory 6, as will be explained further below.

As shown in FIG. 8, the video Direct Memory Access (VDMA) unit 80 has a respective ACT unit 806 and at least some data paths use this ACT unit 806 to perform compression/decompression as and when data is transferred from/to the video Direct Memory Access (VDMA) unit 80. In this respect, it will be appreciated that the video Direct Memory Access (VDMA) unit 80 may, and in embodiments does, support both read and write accesses to memory (and the ACT unit 806 is thus in embodiments operable both to decompress compressed data read into the video Direct Memory Access (VDMA) unit 80 and to compress data that is being written out by the video Direct Memory Access (VDMA) unit 80). The ACT unit 806 of the video Direct Memory Access (VDMA) unit 80 thus supports compression and decompression and may support both lossy and lossless compression schemes.

To facilitate this, the AXI control 802 may thus issue commands to an ACT address generator unit 803 which generates memory transaction requests that are to use the ACT unit 806. These requests pass through a suitable MUX unit 804 to an AXI DMA external bus interface 806 of the video Direct Memory Access (VDMA) unit 80. The respective ACT unit 806 for the video Direct Memory Access (VDMA) unit 80 is thus positioned logically between the AXI DMA external bus interface 806 and the memory management unit (MMU) 66 of the video processing unit (VPU) 2.

The memory access transactions that use the ACT unit 806 can be any suitable and desired memory access transactions that require data to be transferred to/from the video Direct Memory Access (VDMA) unit 80. For instance, as shown in FIG. 8, the video Direct Memory Access (VDMA) unit 80 is associated with various video processing buffers to/from which data can be processed. These may include, for example, a VREF RAM 810, a VYUV RAM 811, a VDST RAM 812 that is operable to write back data from the deblock unit (deblocking filter) 64, and a VSRC RAM 813 that is operable to provide data to the video transform unit 67 for further processing.

The video Direct Memory Access (VDMA) unit 80 also includes a de-swizzle unit (circuit) that is operable and configured to de-swizzle decompressed blocks of data for the input surface to reorder the data elements in those blocks of data into a different order (where, for example, the compressed data is stored in memory in a swizzled or interleaved order) to place the data in a more appropriate order for processing by a motion estimation/compensation unit. As shown in FIG. 8, this is in embodiments integrated within a ‘stuffer’ unit 807 that is (also) operable to perform alignment, replication and format conversion of data.

Thus, when performing a read transaction that uses the ACT unit 806, the compressed data is read into the video Direct Memory Access (VDMA) unit 80 and first decompressed by the ACT unit 806, the ACT unit 806 then provided an uncompressed view of the data to the AXI Direct Memory Access (DMA) external bus interface 806 from which the (uncompressed) data is then processed by the stuffer unit 807 and inserted into a suitable back buffer 808. The (uncompressed) data can then be distributed along the RAM interface 809 to an appropriate video processing buffer, e.g. to the VREF RAM 810, the VYUV RAM 811, or the VSRC RAM 813 for further processing, as desired.

Correspondingly, when performing a write transaction that uses the ACT unit 806 to compress the data as it is written out from the video Direct Memory Access (VDMA) unit 80, for instance when writing data back from the VDST Ram 812 to memory, the (uncompressed) data is in embodiments provided from the VDST Ram 812 to the AXI Direct Memory Access (DMA) external bus interface 806 (via the RAM interface 809, back buffer 808 and stuffer unit 807), and then passed to the ACT unit 806 to perform the desired compression, and the compressed data is then written back to memory 6 (via the memory management unit (MMU) 66, etc.).

As alluded to above, the video Direct Memory Access (VDMA) unit 80 may also support one or more other memory access data paths that do not use the ACT unit 806 to compress/decompress data as it is transferred from/to the video Direct Memory Access (VDMA) unit 80. The AXI control 802 may thus rather than only issuing commands to the ACT address generator 803 to use the ACT data path as described above also issue commands to other memory transaction request generators such as an AFBC address generator 814 and a YUV address generator 815 that may use other data paths. Any requests generated by these units are then similarly passed through the MUX unit 804 to the AXI Direct Memory Access (DMA) external bus interface 806, and the AXI Direct Memory Access (DMA) external bus interface 806 then issues a corresponding transaction request to the memory management unit (MMU) 66 (which transaction request passes through the ACT unit 806 but is not processed thereby (i.e. the ACT unit 806 simply forwards the request on without performing any compression/decompression). Instead, at least for the AFBC access path, any compression/decompression is performed internally to the video Direct Memory Access (VDMA) unit 80 by a respective AFBC encoder 817 or AFBC decoder 818 that is accessible via the RAM interface 809. The video Direct Memory Access (VDMA) unit 80 also includes a formatter 816 which is also accessible via the RAM interface 809.

Again, therefore, the video Direct Memory Access (VDMA) unit 80 in embodiments supports multiple data paths and is (software) programmable between these. However, as will be appreciated from FIG. 8, these data paths again in embodiments share (existing) circuitry such that starting from a video Direct Memory Access (VDMA) unit 80 that already supports an AFBC data path, for example, the data path using the ACT unit 806 can be integrated in a relatively efficient manner and the selection between the data paths than being controlled, e.g. by software.

The technology described herein thus allows efficient integration of different compression data paths into the video processing unit (VPU) 2 and in particular integrates respective, dedicated decoding (or encoding/decoding) units into the respective processing cores 60 of the video processing unit (VPU) 2, with the integrated decoding (or encoding/decoding) units being provided for respective ‘accessor’ units of the video processing unit (VPU) 2. This can provide various benefits compared to other possible approaches.

The foregoing detailed description has been presented for the purposes of illustration and description. It is not intended to be exhaustive or to limit the technology described herein to the precise form disclosed. Many modifications and variations are possible in the light of the above teaching. The described embodiments were chosen in order to best explain the principles of the technology described herein and its practical applications, to thereby enable others skilled in the art to best utilise the technology described herein, in various embodiments and with various modifications as are suited to the particular use contemplated.

1. A video processor comprising one or more processing cores, wherein a processing core comprises:
a memory interface that is operable to manage memory access requests from the processing core; and
a requestor unit that is operable to issue memory transaction requests to the memory interface of the processing core that the requestor unit is a part of, the requestor unit having:
a memory access circuit that is operable to receive memory access requests from the requestor unit and issue corresponding memory transaction requests to the memory interface of the processing core that the requestor unit is a part of; and
a respective decoding unit positioned between the memory access circuit of the requestor unit and the memory interface of the processing core that the requestor unit is a part of, the decoding unit thus being operable and configured to decompress data as and when it is read in to the requestor unit and to provide an uncompressed view of the data to the memory access circuit of the requestor unit.

2. The video processor of claim 1, wherein a same processing core comprises multiple, different requestor units that are operable to issue memory transaction requests to the memory interface of the processing core, and wherein the multiple, different requestor units have respective, separate decoding units.

3. The video processor of claim 1 wherein the or a requestor unit comprises a streaming video Direct Memory Access (VDMA) unit that is operable both to read input frame data into the processing core and to write output frame data to memory, and wherein the respective decoding unit for the VDMA unit is operable and configured to decompress input frame data as and when it is read into the VDMA unit and to compress output frame data as and when it is written out by the VDMA unit.

4. The video processor of claim 1, wherein the processing core is operable to perform motion estimation and/or motion compensation, and wherein the or a requestor unit comprises a video reference frame reading unit that is operable and configured to read reference frame data into the processing core for performing motion estimation and/or motion compensation, wherein the respective decoding unit for the video reference frame reading unit is operable to decompress such reference frame data as and when it is read into the video reference frame reading unit.

5. The video processor of claim 1, wherein a processing core comprises a memory management unit that is operable to perform logical to physical memory address translations, the memory management unit providing the memory interface of the processing core.

6. The video processor of claim 5, wherein the video processor comprises a set of plural processing cores, each processing core of the set of plural processing cores having a respective memory management unit for managing memory access requests from that processing core, and wherein the video processor further comprises a shared memory access sub-system that provides a common interface to memory for the set of plural processing cores, the shared memory access sub-system comprising one or more translation lookaside buffers for caching logical to physical memory address translations.

7. The video processor of claim 1, wherein the memory access circuit comprises a bus interface that is in communication with a communications bus, and via which the requestor unit can initiate bus transactions on the communications bus to perform memory accesses, and wherein when a memory access is a request to read in data that is to be decompressed by the respective decoding unit for the requestor unit, the bus transaction causes the requested data to be read in via, and decompressed by, the decoding unit.

8. The video processor of claim 7, wherein the decoding unit is operable and configured to receive bus transactions initiated by the memory access circuit and to, in response to such a bus transaction, initiate a corresponding bus transaction to perform the memory access.

9. The video processor of claim 7, wherein the requestor unit is also operable to initiate bus transactions to read in data that is not to be decompressed by the respective decoding unit for the requestor unit, wherein such bus transactions are initiated by the same memory access circuit as bus transactions for data that is to be decompressed by the respective decoding unit for the requestor unit, and wherein the memory access circuit of the requestor unit is operable and configured to, when initiating a bus transaction for a memory access request, indicate to its respective decoding unit whether or not the decoding unit is to be used for decompressing the data that is transferred for that memory access request.

10. A data processing system, the data processing system comprising:
a main processor;
a memory; and
a video processor operable to perform video processing for applications executing on the host processor, the video processor comprising one or more processing cores, wherein a processing core of the video processor comprises:
a memory interface that is operable to manage memory access requests from the processing core; and
a requestor unit that is operable to issue memory transaction requests to the memory interface of the processing core that the requestor unit is a part of, the requestor unit having:
a memory access circuit that is operable to receive memory access requests from the requestor unit and issue corresponding memory transaction requests to the memory interface of the processing core that the requestor unit is a part of; and
a respective decoding unit positioned between the memory access circuit of the requestor unit and the memory interface of the processing core that the requestor unit is a part of, the decoding unit thus being operable and configured to decompress data as and when it is read in to the requestor unit and to provide an uncompressed view of the data to the memory access circuit of the requestor unit.

11. A method of operating a video processor, the video processor comprising one or more processing cores, wherein a processing core comprises:
a memory interface that is operable to manage memory access requests from the processing core; and
a requestor unit that is operable to issue memory transaction requests to the memory interface of the processing core that the requestor unit is a part of the requestor unit having:
a memory access circuit that is operable to receive memory access requests from the requestor unit and issue corresponding memory transaction requests to the memory interface of the processing core that the requestor unit is a part of; and
a respective decoding unit positioned between the memory access circuit of the requestor unit and the memory interface of the processing core that the requestor unit is a part of, the decoding unit thus being operable and configured to decompress data as and when it is read in to the requestor unit and to provide an uncompressed view of the data to the memory access circuit of the requestor unit,
the method comprising:
when a requestor unit of a processing core of the video processor requires data to be read from memory in a compressed form:
the memory access circuit of the requestor unit issuing a corresponding memory transaction request to the memory interface of the processing core that the requestor unit is a part of to cause the data to be read into the requestor unit;
the memory interface of the processing core that the requestor unit is a part of then providing the compressed data to the respective decoding unit for the requestor unit for decompressing; and
the decoding unit provided an uncompressed view of the data to the memory access circuit of the requestor unit.

12. The method of claim 11, wherein a same processing core comprises multiple, different requestor units that are operable to issue memory transaction requests to the memory interface of the processing core, and wherein the multiple, different requestor units have respective, separate decoding units.

13. The method of claim 11 wherein the or a requestor unit comprises a streaming video Direct Memory Access (VDMA) unit that is operable both to read input frame data into the processing core and to write output frame data to memory, and wherein the respective decoding unit for the VDMA unit is operable and configured to decompress input frame data as and when it is read into the VDMA unit and to compress output frame data as and when it is written out by the VDMA unit.

14. The method of claim 11, wherein the processing core is operable to perform motion estimation and/or motion compensation, and wherein the or a requestor unit comprises a video reference frame reading unit that is operable and configured to read reference frame data into the processing core for performing motion estimation and/or motion compensation, wherein the respective decoding unit for the video reference frame reading unit is operable to decompress such reference frame data as and when it is read into the video reference frame reading unit.

15. The method of claim 11, wherein a processing core comprises a memory management unit that is operable to perform logical to physical memory address translations, the memory management unit providing the memory interface of the processing core.

16. The method of claim 15, wherein the video processor comprises a set of plural processing cores, each processing core of the set of plural processing cores having a respective memory management unit for managing memory access requests from that processing core, and wherein the video processor further comprises a shared memory access sub-system that provides a common interface to memory for the set of plural processing cores, the shared memory access sub-system comprising one or more translation lookaside buffers for caching logical to physical memory address translations.

17. The method of claim 11, wherein the memory access circuit comprises a bus interface that is in communication with a communications bus, and via which the requestor unit can initiate bus transactions on the communications bus to perform memory accesses, the method comprising:
when the requestor unit of the processing core of the video processor requires data to be read from memory that is to be decompressed by the respective decoding unit for the requestor unit:
the memory access circuit of the requestor unit issuing the corresponding memory transaction request to the memory interface of the processing core that the requestor unit is a part of to cause the data to be read into the requestor unit by initiating a corresponding bus transaction; and
the bus transaction causing the requested data to be read in via, and decompressed by, the decoding unit.

18. The method of claim 17, comprising:
the decoding unit receiving the bus transaction initiated by the memory access circuit; and the decoding unit, in response to receiving the bus transaction initiated by the memory access circuit, initiating a corresponding bus transaction to read in the requested data from memory.

19. The method of claim 17, wherein the requestor unit is also operable to initiate bus transactions to read in data that is not to be decompressed by the respective decoding unit for the requestor unit, wherein such bus transactions are initiated by the same memory access circuit as bus transactions for data that is to be decompressed by the respective decoding unit for the requestor unit,
the method comprising:
the memory access circuit of the requestor unit, when initiating a bus transaction for a memory access request, indicating to its respective decoding unit whether or not the decoding unit is to be used for decompressing the data that is transferred for that memory access request.

20. A computer readable storage medium storing computer software code which when executing on one or more processors performs a method as claimed in claim 11.
